(19) United States
(12) Patent Application Publication
(10) Pub. No.: US 2004/0018838 A1
(43) Pub. Date: Jan. 29, 2004

(54) Method and device for implementing portable guide and guard system

(76) Inventor: Jiun-Bei Chang, Taichung City (TW)

Correspondence Address: APEX JURIS, PLLC, 13194 EDGEWATER LANE NORTHEAST, SEATTLE, WA, 98125, US

(21) Appl. No.: 10/627,053

(22) Filed: Jul. 24, 2003

(30) Foreign Application Priority Data
Jul. 29, 2002 (TW) 091116846

(51) Int. Cl. H04Q 7/20

(52) U.S. Cl. 455/432.3; 455/434; 455/435.1

(57) ABSTRACT

A method and device for implementing a portable guide and guard system is provided. The portable guide and guard device includes a mini-camera, a sound gathering/broadcasting unit and a 3G wireless communicator. The communicator sends the AV signal to remote service center through an AV transmitting function of 3G wireless communication system, and the service personnel in the center answers the user in response to the received live image and sound so as to assist the user contacted therewith. The service center has functions of videoing, monitoring and emergency assistance. Through the combination of the abundant database system, network information searching and various on-line services provided by the service center, the portable guide and guard device can provide foreign language communication/translation, guiding, consulting, network information providing, monitoring, videoing, security protecting and emergency assisting for global foreign tourists, blind and dumb people or security service personnel.

### BACKGROUND OF THE INVENTION

1. Field of the Invention

The present invention relates to a method and a device for implementing a portable guide and guard system. The portable guide and guard system comprises a 3G wireless mobile communication function and utilizes functions of signal exchange and relay process of the 3G wireless communication system, which is going to be imported, so as to cooperate with a service center which combines various functions of Internet. The service center constructs the operation architecture and service mode in a manner of providing the service through voice signal depending on an AV (audio/video) signal received by the portable guide and guard device.

2. Description of the Prior Art

For tourists all over the world, when starting an expected traveling in a foreign country using different language, they might be perplexed by the different language and different culture. In addition, people who might be blind, dumb or needed to be protected/take care or the security/guard will need services such as foreign language communication, translation, guiding, consulting, live videoing, personal security monitoring or remote assistance. However, presently, the technique and product, even the 3G wireless mobile communication system and the peripheral thereof which will be popularized, are still insufficient for these demands.

Followings are the reasons why the functions and applications of 3G wireless mobile communication system 3G cannot satisfy the above-mentioned users and the demands thereof:

1. Because the purpose of 3G mobile phone 3G is to transmit the audio/video signal to the connected opposite side and receive the same signal therefrom, it is designed to be aimed at the operation of the user and not designed for capturing external AV signal.

2. The broadcasting of speaker and sound gathering of microphone of 3G mobile phone are designed for short-range operation and not designed for simultaneously capturing sounds of the user and external environment. Moreover, external hands free handset is generally set to put in the car or on the table and not suitable to be hitched on the neck for receiving sounds from the user and simultaneously the external environment. Furthermore, the additional device on the neck will cause inconvenience for the user.

3. Presently, the video function of the 3G mobile phone in the market is achieved by a camera with fixed focus and diaphragm depending on different purposes and is only for satisfying the purpose of personal visual mobile phone. Therefore, the image processing ability for different situations such as long distance signboard, little distance menu and using at night or under dark light might be insufficient. However, if adopting an auto-focusing and diaphragm adjustable camera, it will increase the volume and weight of the mobile phone so as to disobey the principle of light, thin, shot and small for the modern product and the demand of the customer.

4. The three reasons described above are comparisons aimed at the device for the subscriber, and the other reason is related to the operation system. Besides the demand of the relay function of the communication connecting system, it still needs a remote service center which can receive the AV signal from the user and transmit voice signal and provide related services. Through employing the complete system construction and operation of the service center, the operation and service of the whole portable guide and guard system could be constructed completely.

### SUMMARY OF THE INVENTION

The biggest originality and breakthrough of the implementing method that is constructed by a device having the portable guide and guard function, the communication connecting system and information service station is that it utilizes almost ubiquitous 3G wireless mobile communication system and the function thereof to construct a biggest, most economic, most convenient network for real time translation, guiding, monitoring and information providing. Therefore, under the operation mode of effectively combining the communication and information according to the present invention, the services such as personal tour guiding and security that must be achieved originally by human labor or the functions and demands that can not be achieved by the present products can achieved more satisfying. Thus, the practical value created thereby also goes deep into all strata.

Concluding the implementing method constructed by a device having the portable guide and guard function, the communication connecting system and information service station can provide novel services and functions as follows:

1. Assist the user to communicate in foreign language.

2. Provide the services of guiding and consulting for the user.

3. Replace the user to search, sieve, explain and utilize the information by the service center.

4. Monitor the spot of the user and protect the personal safety thereof.

5. Provide emergency assistance service for the user.

6. Provide the connection among the user, the service personnel and the indicated third party for connection.

The features and efficiencies of the preferred embodiments according to the present invention are further described hereafter coordinating with the following figures.

### BRIEF DESCRIPTION OF THE DRAWINGS

The drawings disclose an illustrative embodiment of the present invention which serves to exemplify the various advantages and objects hereof, and are as follows:

FIG. 1 is a block diagram showing an operation architecture of an implement method and device in a portable guide and guard system;

FIG. 2 is a structural block diagram showing a portable guide and guard device in a portable guide and guard system according to the present invention (namely a structural drawing showing internal units of an independent portable guide and guard device);

FIG. 3 is a schematic view showing a simplified appearance of an independent portable guide and guard device in a preferred embodiment according to the present invention;

FIG. 4 is a schematic view showing a simplified appearance of a separate portable guide and guard device, which is constituted by a 3G mobile phone and an external video/audio input/output device, in a preferred embodiment according to the present invention;

FIG. 5 is a block diagram showing an operation architecture of a service center in the portable guide and guard system according to the present invention;

FIG. 6 is a flow chart showing a basic interaction while a user employs a portable guide and guard device to contact with service personnel in a service center according to the present invention;

FIG. 7 is a flow chart showing the processing procedures of the signal while the user operates the independent portable guide and guard device according to the present invention;

FIG. 8 is a flow chart showing the processing procedures of the signal while the user operates the 3G mobile phone of the separate portable guide and guard device according to the present invention;

FIG. 9 is a flow chart showing an emergency calling system and the processing procedures of the signal thereof while the user presses an emergency button of the independent portable guide and guard device in a preferred embodiment according to the present invention;

FIG. 10 is a flow chart showing the emergency measures and the processing procedures of the signal thereof while the service center receives an emergency call according to the present invention;

FIG. 11 is a flow chart showing the operation system and the processing procedures of the signal thereof while the service center employs a function of emergency calling in a preferred embodiment according to the present invention;

FIG. 12 is a flow chart showing the operation system and the processing procedures of the signal thereof while the service center employs a function of emergency assisting in a preferred embodiment according to the present invention;

FIG. 13 is a flow chart showing a connecting service among three parties which is provided by the service center and the processing procedures of the signal thereof in a preferred embodiment according to the present invention;

FIG. 14 is a schematic view showing a main menu shown on a monitor of a human-machine interface within the service center according to the present invention;

FIG. 15 is a schematic view showing emergency assisting functions shown on a monitor in a preferred embodiment according to the present invention; and

FIG. 16 is a schematic view showing functions of connecting among three parties shown on a monitor in a preferred embodiment according to the present invention.

### DETAILED DESCRIPTION OF THE PREFERRED EMBODIMENT

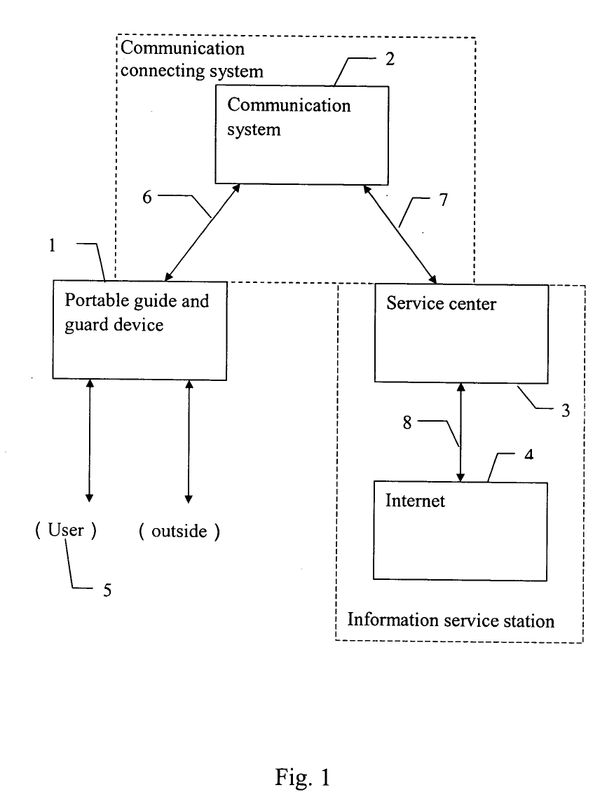

Please refer to FIG. 1 which illustrates a block diagram showing an operation architecture of an implement method and device in a portable guide and guard system according to the present invention. The portable guide and guard system includes a portable guide and guard device, a communication connecting system and an information service station.

The communication connecting system further includes a wireless communication network, a communication system and a wired communication network.

And, the information service station further includes a service center, an Internet connection network and Internet.

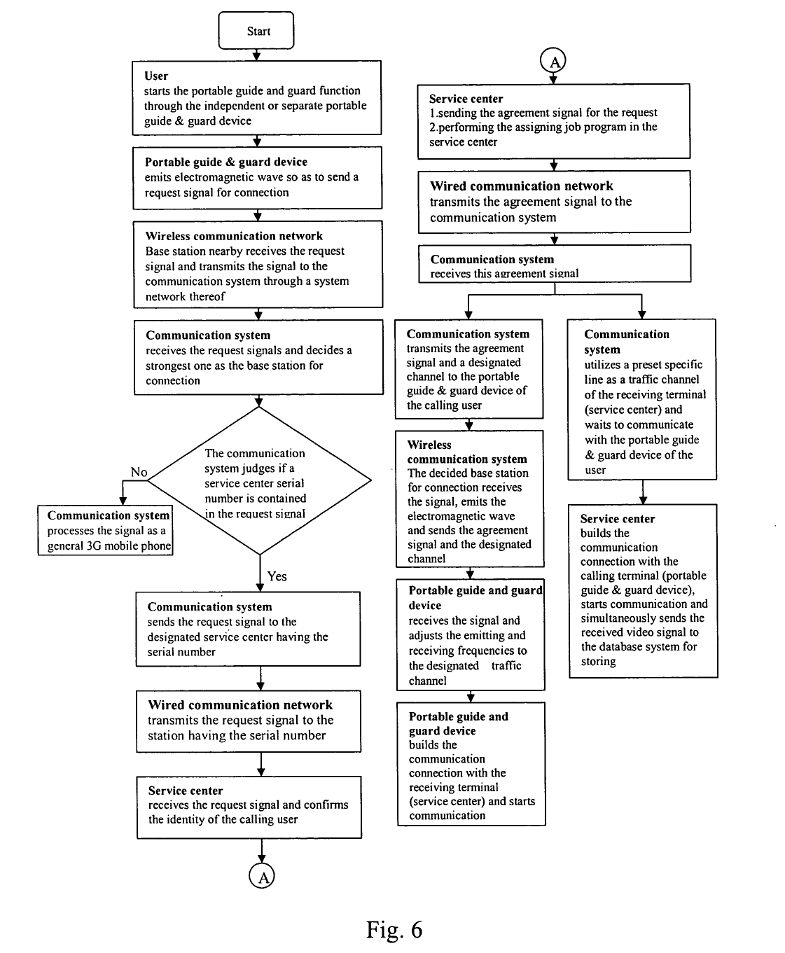

Moreover, according to FIG. 1, the portable guide and guard system with a complete function will include eight portions: (A) a portable guide and guard device 1, (B) a communication system 2, (C) a service center 3, (D) Internet 4, (E) a user 5, (F) a wireless communication network 6, (G) a wired communication network, and (H) an Internet connection network 8. As to the connecting relation or correlation among these portions, it can be realized through the flow chart showing a basic interaction between a user and a service center shown in FIG. 6 and the contents thereof.

These eight portions are described as follows:

A. Portable Guide and Guard Device 1:

For implementing the portable guide and guard system, the portable guide and guard device 1 can be separated into two types:

An independent portable guide and guard device (1A) which is an exclusive for the portable guide and guard system and is characterized in that all units needed for operating the portable guide and guard function are mounted in an independent device so that it will not need other devices.

A separate portable guide and guard device (1B) which is constituted by a 3G mobile phone 1c and an external video/audio input/output device 1b and is characterized in that units needed for implementing the portable guide and guard function are respectively mounted in 3G mobile phone 1c and in the external video/audio input/output device 1b. On the other hand, it utilizes the existing units for video/audio transmission and processing and power supply in 3G mobile phone and further cooperates with the external video/audio input/output device 1b so as to be commensurate with the independent portable guide and guard device 1A. This design allows the user to add the external video/audio input/output device as needed. Therefore, not only the 3G mobile phone 1c can have two efficiencies, but also some relative units will be in the mobile phone 1c so as to reduce the volume and weight of the external video/audio input/output device 1b and further the price.

In the description of the present invention, if it is not specifically recited, the portable guide and guard device 1 generally refers to one of the independent portable guide and guard device 1A and the separate portable guide and guard device 1B. The description is relevant to the common functional options of the two and irrelevant to the arranging manner of the inner units.

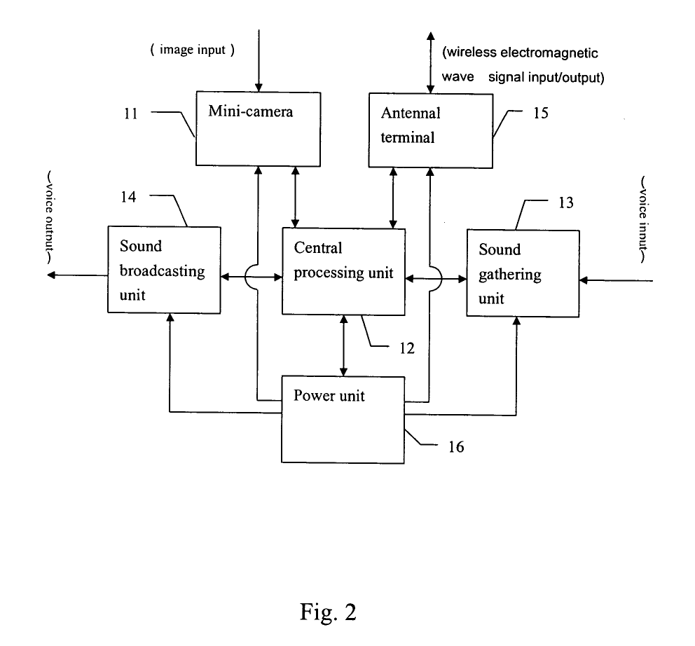

Please refer to FIG. 2 which illustrates a structural block diagram showing the portable guide and guard device 1 in a portable guide and guard system according to the present invention. FIG. 2 simultaneously represents the functional architecture of both the independent portable guide and guard device 1A and the separate portable guide and guard device 1B, and furthermore, because the independent portable guide and guard device 1A contains all the implement units, FIG. 2 also represents a structural drawing of the internal units of the independent portable guide and guard device 1A. Hereafter, it takes the independent portable guide and guard device 1A as a representative for explaining the purpose and function of each internal unit and external unit and then it further explains the difference due to the arranging manners of the independent portable guide and guard device 1A and the separate portable guide and guard device 1B.

The main six units of the independent portable guide and guard device 1A includes:

a. Mini-camera 11: The mini-camera at least includes an optical camera and an image processing element. After an external optical image captured by the optical camera having an automatic focusing and an adjustable sensitization passes through the image processing element, an analog signal thereof is transformed into a digital signal which is then inputted into a central processing unit for processing a signal output procedure.

b. Central processing unit 12: The central processing unit is mainly a computer component, wherein a video signal from the mini-camera 11 and an audio signal from a sound gathering unit 13, which are passed through the output signal procedure of the central processing unit, are transmitted to an antennal terminal 15 for emitting, and an external electromagnetic wave received by the antennal terminal 15 is decoded and then transmitted to a sound broadcasting unit (14) for broadcasting the sound.

c. Sound gathering unit 13: The sound gathering unit 13 includes a fixed and an external microphone accessories and a sound gathering element, wherein the fixed microphone which is positioned above a panel of the device for receiving the external sounds. An external sound received by the fixed microphone is transmitted to the sound gathering element for proceeding a signal processing. Besides, the sound gathering unit can also cooperate with an external earphone/microphone device. When both the fixed and the external microphone accessories are used, the sound gathering element will automatically proceed an echo eliminating function for avoiding the echo due to the simultaneous operation of the two microphones.

d. Sound broadcasting unit 14: The sound broadcasting unit includes a fixed speaker, an external earphone and a sound broadcasting element positioned. When a voice signal from a signal base station received by the antennal terminal 15 is processed by the sound broadcasting element, it will be transmitted to the speaker positioned above the panel of the device so as to broadcast the sound.

e. Antennal terminal 15: The antennal terminal includes an emitter, a receiver and an antenna. The function thereof is to emit an encoded signal from the central processing unit 12 which is electro-magnetically modulated by the emitter and transmit a wireless electromagnetic wave signal, which is from the communication system 2 through the wireless communication network 6 and then demodulated by the receiver, to the central processing unit 12 for signal decoding and processing other sequential procedures.

f. Power unit 16: The power unit is a super thin lithium battery or a high efficiency battery for providing all units the power.

The independent portable guide and guard device 1A has an individual information such as an independent phone number, user's identification number, code or secret code. If the user needs to dial out, he can tell the service personnel 37 who he wants to contact and the service personnel will manually work a telephone switchboard. When the independent portable guide and guard device 1A enters a normal mobile phone situation, a main computer 31 within the service center 3 will automatically stop the original portable guide and guard function and automatically recover the function until the user presses a portable guide and guard function button 13a for stop the communication by the phone.

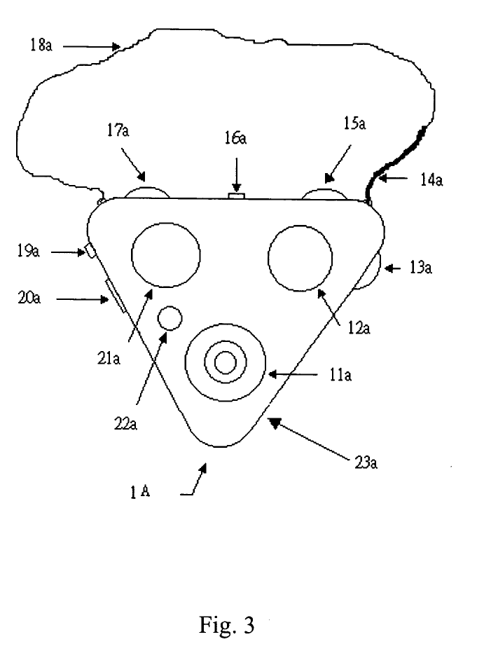

FIG. 3 is schematic view showing a simplified appearance of an independent portable guide and guard device 1A in a preferred embodiment according to the present invention. All the elements in FIG. 3 are listed in Table 1. Table 1 is an explanation of the function and operation of the external elements of the independent portable guide and guard 1A in a preferred embodiment.

TABLE 1

| | Element/ | | | |
|---|---|---|---|---|
| | Indicator | FUNCTION | EXPLANATION | |
| external | Power | Turn/off | 1. | Power on the power supply, |
| element | switch | power | | which is provided by detachable |
| | (15a) | supply | | battery (23a). |
| | | | 2. | Implement the standby sub- |
| | | | | program, start to search the com- |
| | | | | munication system station and |
| | | | | confirm the signal of the com- |
| | | | | munication system (2) is con- |
| | | | | nectable so that the portable |
| | | | | guide and guard device 1 enters |
| | | | | the standby status. |
| | | | 3. | Under standby status, the port- |
| | | | | able guide and guard device 1 |
| | | | | has the function of receiving the |
| | | | | dialed-in phone call from the |
| | | | | service center. |
| | | | 4. | Press this button under standby |
| | | | | or using status, it will shut down |
| | | | | the power. |
| | Optical | Capture | | Through the auto-focusing and |
| | camera | external | | optical sensing optical camera |
| | (11a) | optical | | (11a), the external optical image |
| | | image | | can be captured, passed through |
| | | | | an image processing element to |
| | | | | transfer the analog signal into |
| | | | | the digital signal and then in- |
| | | | | putted into the central processing |
| | | | | unit (12) for processing signal |
| | | | | output procedure. |
| | Fixed | Receive | | The fixed microphone is |
| | micro- | external | | mounted on the panel of the de- |
| | phone | sounds | | vice for receiving the external |
| | (12a) | | | sound through a sound gathering |
| | | | | element, and then after being |
| | | | | processed, the signal is trans- |
| | | | | mitted to the central processing |
| | | | | unit (12). |
| | Speaker | Broadcast | | The voice signal received by the |
| | (21a) | sound | | antennal terminal (15) from the |
| | | | | signal base station is processed |
| | | | | by the broadcasting element and |
| | | | | then transmitted to the speaker |
| | | | | on the panel for broadcasting the |
| | | | | sound. |
| | Portable | Power on/off | 1. | Press this button as standby; the |
| | guide and | portable | | sub-program of power on the |
| | guard | guide guard | | portable guide and guard |
| | function | function | | function is initiated so as to send |
| | button | | | a signal for requesting to con- |
| | (13a) | | | nect with service center. Then, |
| | | | | the communication system (2) |
| | | | | immediately builds the signal |
| | | | | connection between the portable |
| | | | | guide and guard device (1) and |
| | | | | the service center (3). |
| | | | 2. | When entering the status under |
| | | | | using, the portable guide and |
| | | | | guard device can receive phone |
| | | | | calls transferred from service |
| | | | | center. |
| | | | 3. | Under using, it will implement |
| | | | | the portable guide and guard |
| | | | | function after pressing the but- |
| | | | | ton so as to go back to standby |
| | | | | status. |
| | Speaker | Power on/off | | Under using, the sound output of |
| | mute but- | speaker mute | | the speaker (21a) on the panel of |
| | ton (17a) | function | | the device can be closed. One |
| | | | | more press, the sound output of |
| | | | | the speaker (21a) can be re- |
| | | | | covered. The function of ex- |
| | | | | ternal microphone accessory |
| | | | | will not be influenced. |
| | Volume | Regulate the | 1. | Using method: press upper but- |
| | regulating | volume of | | ton for magnifying volume; |
| | button | the speaker | | press lower button for reducing |
| | (20a) | and the | | volume. |
| | | earphone | 2. | This button can simultaneously |
| | | | | regulate the volume of speaker |
| | | | | (21a) and external earphone. |
| | Emergen- | 1. Power on | 1. | Press this button as the portable |
| | cy calling | power sup- | | guide and guard device (1) is |
| | button | ply and | | turned off or standby, the power |
| | (22a) | portable | | supply and the portable guide |
| | | guide and | | and guard function both can be |
| | | guard | | automatically initiated so as to |
| | | function | | complete the connection wit the |
| | | 2. Emer- | | service center (3). |
| | | gency calling | 2. | Simultaneously transmit the |
| | | service | | emergency calling signal. This |
| | | center for | | signal will immediately induce |
| | | immediate | | an alarm bell and warning light |
| | | help | | on screen of the human-machine |
| | | | | interface (36) in front of the |
| | | | | service personnel (37). |
| | Earphone/ | External | 1. | The user utilizes the external |
| | micro- | earphone/ | | earphone for communicating |
| | phone | microphone | | with service personnel (37) so |
| | plug (19a) | device | | as to reduce external inter- |
| | | | | ference. Through cooperating |
| | | | | with speaker mute function, it |
| | | | | can make the contactor to lose |
| | | | | the sound response of the service |
| | | | | personnel or the broadcasted |
| | | | | music. |
| | | | 2. | By conversing through the exter- |
| | | | | nal microphone accessory, the |
| | | | | volume can be reduced and also |
| | | | | reduce the external interference. |
| | Antenna | Emit and | | A soft antenna can be adopted |
| | (14a) | receive | | and fitted into the chain (18a) so |
| | | wireless | | that the whole modeling of the |
| | | electro- | | portable guide and guard device |
| | | magnetic | | (1) might not be destroyed and |
| | | wave | | still can achieve the functions of |
| | | | | signal receiving and |
| | | | | transmitting. |
| indi- | Status | Show status | 1. | Standby: fixed frequency green |
| cator | indicator | of power on, | | light |
| | (16a) | standby and | 2. | Connecting: orange light |
| | | connecting | | |
| | | Show | | When the remain power lower |
| | | insufficient | | than 20% or other set value, the |
| | | power | | lower power indictor will flash |
| | | supply | | a red light at a fixed frequency |
| | | Show mute | | Yellow light |
| | | status of | | |
| | | speaker | | |

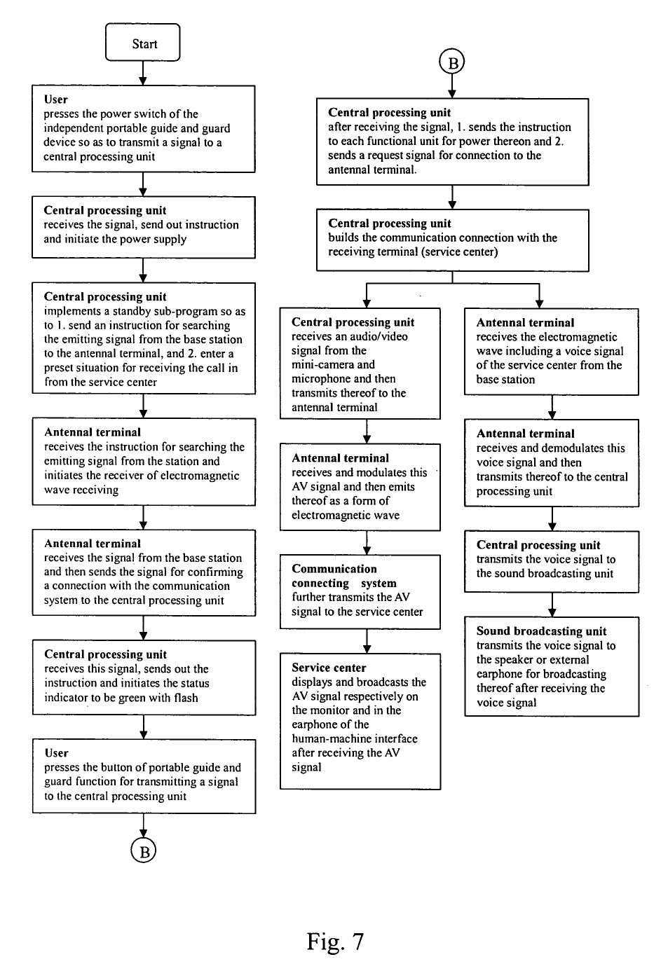

In addition, through FIG. 7 which is the flow chart showing the processing procedures of the signal while the user operates the independent portable guide and guard device 1A, it can be understood more completely.

For these preferred portable guide and guard devices 1, those skilled in the art could alter thereof depending on the spirit and the functional design of the present invention as follows:

1) The portable guide and guard device can be externally connected to the global locating apparatus and installed the processing functions needed therefore for capturing the location data of the portable guide and guard device, namely the user's location, and then transmitting the data to the service center for guiding or security monitor.

2) The portable guide and guard device can be fixed on a helmet, a car, a searchlight or other portable apparatus and cooperates with the external earphone/microphone. And, the portable guide and guard device also can be taken apart from the base of the apparatus, so that the angle of view will be better without influencing other missions, for example, for the security service personnel.

3) The portable guide and guard device can also add the function and element of remote thereinto for controlling the angle of optical camera and telescopic camera lens.

However, these equivalent alternations belong to the designable items of the present invention and still contained in the claim of the present invention.

The other device with the same function is to employ the existing 3G mobile phone 1c and an external device having a mini-camera and a microphone/speaker. This external device having the mini-camera and the microphone/speaker is so called an “external video/audio input/output device 1b” in the present invention. And, the assembly device of the 3G mobile phone and the external video/audio input/output device 1b is namely the “separate portable guide and guard device 1B” in the present invention.

Because this kind of external video/audio input/output device 1b belongs to the optional additional functions of 3G mobile phone, after the user completes the application to the service center 3, the service center 3 will take the telephone number of the 3G mobile phone 1c as the connecting identification number and enter the number and relative data of the member. Moreover, the service center 3 provides the settings for the user 5 services and simultaneously the serial number of the service center 3 to the applicant. When the user 5 first uses portable guide and guard device, he has to first enter the functional selections of the 3G mobile phone 1c and then the sub-selection for the serial number for entering the serial number, and then this function can be used.

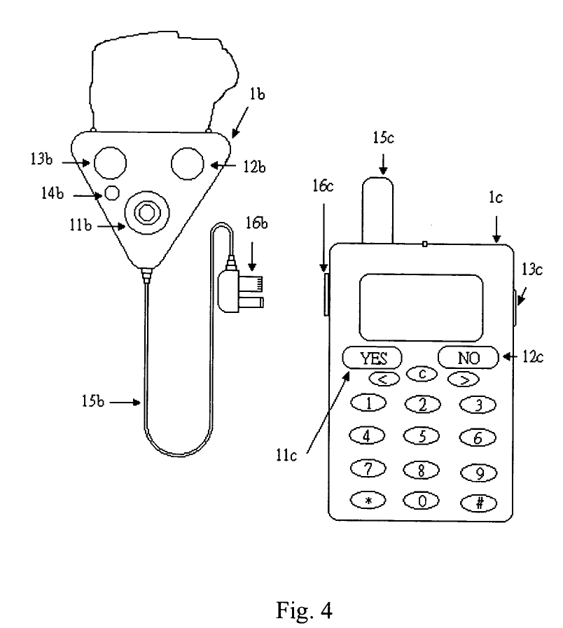

Please refer to FIG. 4, which is a schematic view showing a simplified appearance of a 3G mobile phone 1c and the external device having the mini-camera and the microphone/speaker (the external video/audio input/output device 1b) in a preferred embodiment according to the present invention.

On this external video/audio input/output device 1b, besides the mini-camera 11b, the microphone 12b, and the speaker 13b, a power/AV signal line 15b and plug thereof, the only button is an emergency calling button 14b. The main functions of the three units of the external video/audio input/output device 1b are described as follows:

a. Mini-camera 11b: The mini-camera includes an optical camera and an image processing element. The function thereof is that after an external optical image captured by the optical camera having an automatic focusing and an adjustable sensitization passes through the image processing element, an analog signal thereof is transformed into a digital signal which is then inputted into a central processing unit of the 3G mobile phone through the power/signal line 15b for processing a signal output procedure.

b. Microphone 12b: The microphone is a fixed one positioned above a panel of the external video/audio input/output device 1b for receiving the external sounds. An external sound received by the fixed microphone is transmitted to the sound gathering element of the 3G mobile phone 1c through the power/signal line 15b and then to the central processing unit of the 3G mobile phone 1c for proceeding.

c. Speaker 13b: The speaker 13b is a fixed speaker positioned above a panel of the external video/audio input/output device 1b. The function thereof is that when a voice signal from a signal base station received by the antennal terminal 15 is processed by the sound broadcasting element of the 3G mobile phone 1c, it will be transmitted to the speaker 13b positioned above the panel of the external video/audio input/output device 1b through the power/signal line 15b so as to broadcast the sound.

d. Emergency calling button 14b: The emergency calling button 14b possesses a function of initiating the power supply for the 3G mobile phone and the portable guide and guard. Namely, if the user presses the button under the situation that the plug of the power/signal line 15b is plugged into the 3G mobile phone but the power of the mobile phone is not turned on, the central processing unit of the 3G mobile phone 1c will automatically turn on the power after receiving this signal, implement sub-programs and start to search the communication system base stations for confirming the signal connection therebetween. Then, after the mobile phone is in the stand-by condition, the central processing unit of the 3G mobile phone 1c will again implement the sub-program of portable guide and guard, build the connection with the service center 3 and send the emergency mayday signal. This signal will immediately induce an alarm bell and warning indicator in the human-machine interface 36 and be recognized by the service personnel 37 in front of the human-machine interface 36, so that the service personnel 37 will immediately notice the emergency situation of the user 5 and quickly provide the necessary assistances.

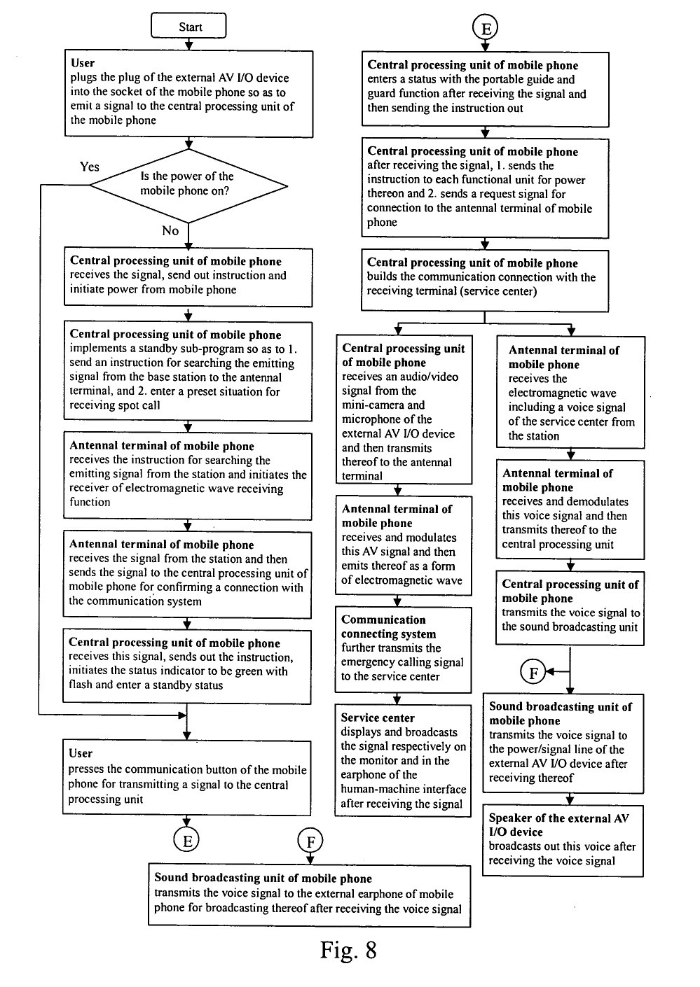

Other units, buttons and indicators of the independent portable guide and guard device 1A are respectively replaced by relative units, buttons and indicators of the 3G mobile phone, wherein each element is described in Table 2. Table 2 is a comparison of each unit, button, indicator and function and operation of the 3G mobile phone 1c and the external video/audio input/output device 1b with those of the independent portable guide and guard device 1A. In addition, through FIG. 8 which is the flow chart showing the processing procedures while the user operates the 3G mobile phone 1c and the external video/audio input/output device 1b, it can be understood more completely.

TABLE 2

| | Independent | | |
|---|---|---|---|
| | Portable | | |
| | Guide and | Separate Portable Guide and Guard Device | |
| | Guard | External AV I/O | |
| | Device | device | 3G Mobile Phone |
| Internal | Mini-camera | Yes | No |
| element | | | (the original optical |
| | | | camera will has no function |
| | | | as implementing portable |
| | | | guide and guard function) |
| | Central | No | Yes |
| | processing | | (all signals, data and |
| | unit | | control instructions are |
| | | | processed by 3G mobile |
| | | | phone) |
| | Sound | Only fixed | Only external microphone |
| | gathering | microphone | accessory and sound |
| | unit | | gathering element |
| | Sound | Only speaker | Only external earphone |
| | broadcasting | | and broadcasting element |
| | unit | | |
| | Antennal | No | Yes |
| | terminal | | |
| | Power unit | No | Yes |
| External | Power | No | Yes |
| button, | switch | (after the plug of the | |
| plug | | power/signal line is | |
| and in- | | plugged therein, the | |
| dicator | | power switch has | |
| | | the ability to initiate | |
| | | the power and then | |
| | | simultaneously turn | |
| | | on/off the power | |
| | | of 3G mobile | |
| | | phone) | |
| | Portable | No | This button is not existed |
| | guide | | but this function is existed |
| | and guard | | (after the plug of the |
| | function | | power/signal line of the |
| | button | | external AV I/O device is |
| | | | plugged into the socket of |
| | | | 3G mobile hone, this |
| | | | function can be turned |
| | | | on/off through the |
| | | | communicating button of |
| | | | the phone) |
| | Speaker | No | This button is not existed |
| | mute | | but this function is existed |
| | button | | (can be turned on/off this |
| | | | function through the |
| | | | speaker mute sub- |
| | | | selection of the portable |
| | | | guide and guard function |
| | | | menu of 3G mobile |
| | | | phone) |
| | Volume | No | Yes |
| | regulating | | |
| | button | | |
| | Emergency | Yes | No |
| | calling | | |
| | button | | |
| | Earphone/ | No | Yes |
| | microphone | | |
| | plug | | |
| | No | power/signal line | Plug (16c) for power/signal |
| | | (15b) and plug (16b) | line |
| | Status | No | Yes |
| | indicator | | |
| function | Phone call | No | General wireless |
| | dial out or | | communication function of |
| | dial in | | mobile phone |
| | (should be | | |
| | transferred | | |
| | by the ser- | | |
| | vice center) | | |
| | No need | No | The user has to previously |
| | (set by the | | self-set the serial number |
| | service | | of the service center in the |
| | center | | function menu of mobile |
| | altogether) | | phone so that this function |
| | | | can be used. |

The 3G mobile phone includes all needed units, buttons and indicator for implementing the portable guide and guard method as follows:

1) Central processing unit: All signals, data and control instructions in the external video/audio input/output device 1b are processed by the central processing unit of the 3G mobile phone 1c.

2) Sound gathering unit: The sound gathering unit includes an external microphone accessory and a sound gathering element. When the portable guide and guard function is working, an external sound received by the microphone of the external video/audio input/output device 1b is inputted into the sound gathering element of the 3G mobile phone 1c through the power/signal line 15b and transmitted to the central processing unit of the 3G mobile phone 1c for proceeding a voice output processing, and, on the other hand, a voice from the microphone of the 3G mobile phone 1c is transmitted to the central processing unit of the 3G mobile phone 1c for proceeding the voice output processing. Furthermore, the sound gathering element has an ability of echo elimination which is initiated when the microphones of the external video/audio input/output device (1b) and the 3G mobile phone 1c are simultaneously operated so as to reduce an echo.

3) Sound broadcasting unit: The sound broadcasting unit includes an external earphone accessory and a broadcasting element. When the portable guide and guard function is working, a voice signal from the signal base station received by an antennal terminal of the 3G mobile phone 1c will be processed by the broadcasting element and then transmitted to the speaker 13b of the external video/audio input/output device 1b through the power/signal line 15b for broadcasting said voice, and, on the other hand, a voice from a service center 3 will be received through the external earphone of the 3G mobile phone 1c.

4) Antennal terminal: All emissions and receipts of the wireless electromagnetic wave of the external video/audio input/output device 1b are processed by the antennal terminal 15c of the 3G mobile phone 1c.

5) Power unit: All power demanded by the external video/audio input/output device 1b is supplied by the battery of the of power unit of the 3G mobile phone 1c.

6) Power switch: After the plug of the power/signal line 15b of the external video/audio input/output device 1b is plugged into a socket of the 3G mobile phone, the power switch immediately has an ability to initiate a power supply, and then the external video/audio input/output device 1b will be synchronous to an operation of the power switch 12c of the 3G mobile phone 1c.

7) A function of power on/off the portable guide and guard: After the plug of the power/signal line 15b of the external video/audio input/output device 1b is plugged into the socket of the 3G mobile phone, the portable guide and guard function is initiated/shut down through pressing a confirm button 11c of the 3G mobile phone 1c.

8) A speaker mute function: This function can be initiated/shut down through choosing a mute sub-selection in a menu of portable guide and guard of the 3G mobile phone since the 3G mobile phone doesn't own an independent button therefore.

9) Volume regulating button: A volume of the speaker of the external video/audio input/output device 1b can be controlled by the volume regulating button 13c of the 3G mobile phone 1c.

10) Earphone/microphone socket: the earphone/microphone can be externally plugged by an earphone/microphone accessory of the 3G mobile phone 1c to obtain a sound gathering function from the microphone and a sound broadcasting function from the earphone when the portable guide and guard function is under using.

Besides, the optical camera, fixed speaker and fixed microphone originally on the 3G mobile phone 1c are non-working, when the portable guide and guard function is under using.

B. Communication System 2:

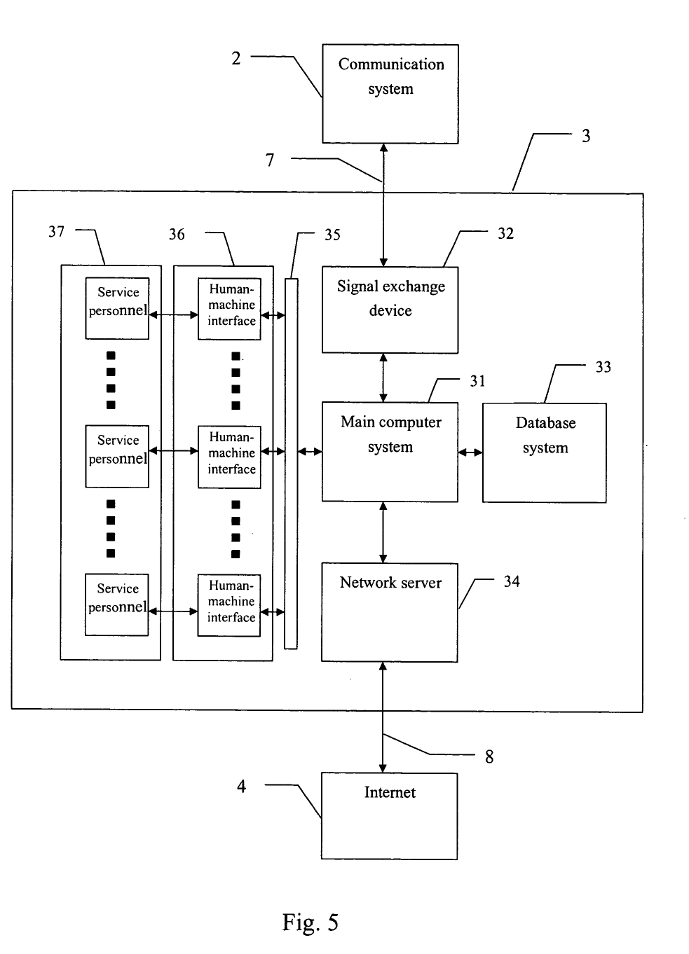

As shown in FIGS. 1 and 5, the operation of the whole portable guide and guard device 1 mainly relays on the wireless communication network 6 constructed by the telecommunication company which provides the 3G wireless communication service and the signal/main computer system thereof which implements the signal exchange and processing to be a signal transmission medium. The signal/main computer system for responding for the signal exchange and processing is namely the communication system 2 in the present invention, wherein the wireless communication network and the communication system are respectively the 3G wireless communication system.

The wireless communication network 6 is constituted by cellular wireless channels that are formed by thousands of base stations and responsible for implementing the signal connection of the 3G wireless communication device in the user terminal. All demands of the base stations will be relayed to an exchanger, and then the exchanger and the control and management center will implement the signal exchange and processing needed in this communication. The base station and the exchanger are connected through the optical fiber, point-to-point microwave connection or telephone line, and plural exchangers. Furthermore, the control and management center will also be connected together for managing the signal exchange and processing of all communication demands within and outside the system and providing all kinds of cellular services to the home system. The connection network among plural exchangers and the communication apparatus, computer soft/hardware apparatus of control and management center is namely the communication system 2 in the present invention.

Because the whole system is built on the communication system 2 of the same telecommunication company, the service centers 3 which are operated at the same time will be respectively set by different organization or enterprise according to different purposes (such as travel service, service for blind people or mobile monitoring system of the security service firm). Therefore, when each service center 3 applies this service to the telecommunication company, the telecommunication company will give each service center an exclusive number and the computer processing center within the telecommunication company will also set this number therein. Of course, the system service provider of the 3G mobile phone also can build a service center 3 by itself for providing this portable guide and guard service, or this portable guide and guard service can be provided by several service centers having identical or different properties, and thus, it will need different serial numbers. In the future operation, the communication system 2 also can take the serial number received by the service center 3 as an identification number, and the signal connection of the portable guide and guard device 1 will directly be handover to an designated service center 3 so that both sides can process the operation of the portable guide and guard device without adopting the telecommunication exchange processing which is applied in the general dialing method.

The direct handover of the communication system 2 is namely a specific line connection mode between the communication system 2 and the wired communication network 7 of the service center 3. After the service dials into the communication system 2 which will then notify the service center 3, the main computer system 31 within the service center 3 will directly proceed and immediately connect to the human-machine interface 36 of the service personnel 37 which is designated by an assigning program so that the user can immediately converse with the service personnel 37 almost without waiting. Namely, the processes of signal exchanging and processing of the communication system 2 eliminate the original procedures of waiting for communicating by the receiver and then connecting the line and signal processing steps needed therein. Moreover, the telecommunication company of the communication system 2 also can save the communication channel, time and related cost which are consumed as waiting so as to achieve a high speed and high efficiency service. Unless the lines are busy, the communication system 2 won't send a busy sound or voice signal to the user who is operating the portable guide and guard device 1 for noticing the user the busy situation, which is always happened in the general mobile phone.

C. Service Center 3:

The architecture block of the service center 3 in a preferred embodiment according to the present invention is shown in FIG. 5. The main flow path of the system is as follows: after the signal exchange device 32 of the service center 3 captures and processes the image and sound signal of the user from the signal connection between the communication system 2 and the service center 3, the signal will be transmitted to the main computer 31 for the sequential processing; the main computer system 31 outputs the signal to the human-machine interface 36 in front of the service personnel 37 through the internal network 35 so that the service personnel 37 can receive the live image and sound through the monitor and earphone of the human-machine interface 36 and then provide services e.g., guiding and translation assistance for the user 5; and further the service personnel 37 can utilize the searching function for obtaining data from the database system 33 or the searching engine of the self-built website for capturing traveling or related data from various website in Internet 4 so as to provide thereof to the user 5 or indicate the user. Following will be the description of main function of each sub-system:

a. Main computer system 31: The main computer system 31 can be designed by the methods of: adopting it as an independent computer component or adopting it to incorporate the data processing and storing functions or parts thereof of signal exchange device 32, database system 33, network service server 34 or human-machine interface 36 so as to be a multi-functional computer module.

Besides the main works of interface processing and system management among all sub-systems described above, another main work is to set up and manage the self-built website by the service center 3. The functions of the website include: an brief introduction of company of the service center 3 and the service items, an on-line service interface for the personal web page of the user 5 and therewith the service center 3, a function of network searching engine and information collection and arrangement, on-line commercial publish of all cooperating companies, and function of super connection.

b. Signal exchange device 32: it is a network apparatus for implementing the connection between the service center 3 and the communication system 2 through the wired communication network 7 so as to exchange the information within the service center 3.

c. Database system 33: it at least includes a central processor and a recording medium (such as hard discs), wherein the central processor can be utilized to process and then store the data bit into the data structure of the recording medium or read the data from the data structure of the recording medium. The data structure can be constructed through the database system in the prior art. Another function of the system is that all the input and output signal can be stored therein for future viewing.

d. Network server 34: it is a hardware platform for the software of Internet access service especially for the user. The main work thereof is to build the website of the service center 3 within the main computer system 31 and provide the needed signal access and processing for the 24 hours connection with the global information network.

e. Internal network 35: it is mainly to construct the signal connecting bridge between the main computer system 31 and plural human-machine interfaces 36 and belongs to parts of a general LAN (local area network).

f. Human-machine interface 36: it includes a computer mainframe, a monitor, a set of input device with a keyboard and a mouse and a set of external earphone/microphone device. Each service personnel is allotted a set of human-machine interface 36 device. Furthermore, for quickly and efficiently providing the user 5 related information and service by the service personnel, it has to have a humanized appearance of picture and display format, and all the operation methods and flow paths are based on the principle that the service personnel can easily achieved. This operation condition can be achieved by a program for the human-machine interface which can be designed through the technique in the prior art. In addition, the main computer system 31 and the human-machine interface 36 are typically a client-server model.

g. Service personnel 37: they belong to a link in the whole operation architecture SO as to search and sift data for the user 5 and are media of data illustration and utilization. Then, the human-machine interface 36 is namely the tool for the service personnel 37 to achieve the mission. Therefore, besides the ability of computer and Internet operation, the service personnel 37 should own the special ability for the provided service.

Another responsibility and work of the service personnel 37 is to monitor the spot of the user 5 so as to protect the safety thereof. They have to notice the relative organization or people in a shortest time so as to effectively protect the user and provide the target needed assistance.

For some function-simplified architectures, they might only own one service center for the information service station without Internet connection network and Internet. This kind of service center eliminates the sub-system of network server and the service center website built by the main computer and won't provide the functions such as Internet information and on-line service. Another method for building the service center 3 is to employ the telecommunication company which provides the communication connecting service to provide this service. This method can have a best efficiency on building the wired communication network 7. In this mode, the user 5 more possibly obtains this service from the already owned separate portable guide and guard device 1B. Still another service center 3 is to be built departed from the telecommunication company by independent enterprise or organization, and then the service center 3 can request the telecommunication company to provide the communication connecting service. This kind of service center 3 might provide specialized service items.

The preferred embodiment for each sub-system of the service center 3 described above can be combined or subdivided depending on the spirit and functional design of the present invention and simplified or complicated various operations and flow paths thereof for adapting various applications by one skilled in the art and still fall into the range of the present invention. Also, the service center built based on the implement method of the portable guide and guard system of the present invention is included in claims appended, no matter incorporating into the telecommunication company or independently departing therefrom.

D. Internet 4

Internet 4 is a collection of large amount of computer networks which are connected to each other, and depending on IP (Internet Protocol) and TCP (Transmission Control Protocol), the encoding and decoding of the signals on Internet can be done so as to be accessed. Just because huge data and all kinds of on-line services can be obtained from Internet 4, for the user 5 in the foreign country for traveling, it can satisfy most demands. This is also one of the practical values provided by the implement method constructed by the portable guide and guard device 1 and the communication connecting system and the information station.

E. User 5

The user 5 is namely the person who utilizes the communication connecting system provided by the portable guide and guard device 1 to obtain needed information and related service from the service personnel 37 within the service center 3. Actually, a person who has demands of foreign language communicating, guiding, consulting, information providing, monitoring, videoing and security defending etc. might become the user 5 of the portable guide and guard device 1. In the future, the possible people for service providing might be foreign tourists, blind people, dumb people, women always late for home, people needed for guarding, security service personnel and commercial firms always need to service foreign tourists.

E. Wireless Communication Network 6

The portable guide and guard device 1 and the communication system 2 of the telecommunication company are namely communicated by wireless communication function for transmitting the electromagnetic wave so as to achieve the purpose of communication connection.

F. Wired Communication Network 7

The signal connection between the communication system 2 and the service center 3 is firstly the wireless communication network 6 which passes through the relay function of the signal exchange in the communication system 2 and then is altered the wired communication connecting method so as to build the connection therebetween and implement the portable guide and guard operation. Meanwhile, the connecting line of the wired communication connecting method is namely the wired communication network 7 of the present invention.

G. Internet Connection Network 8

Internet connection network 8 utilizes WAN (Wide Area Network) to connect to local ISP through previously bought or rent bandwidth and then gradually connect to the large-scale framework of the network so as to connect with websites or subscribers all over the world. The method through WAN (Wide Area Network) to connect to local ISP is identical to the third network communication connecting method described in the wire communication network 7, namely a line (generally a rent T3 or T4 special line) pulled from the network server 34 within the service center 3 is connected to POP of the fixed telephone network and then connected to local ISP through the standard exchange apparatus of the telecommunication company. However, the information access over Internet must begin at registering the IP address and DNS address of the website and then set in the network server so that the access can be done.

The contents described above are mainly employed to explain the implementing method constituted by the portable guide and guard device 1, the communication connecting system and the information station, wherein the operation architecture and the functions of the main units or the sub-systems give the whole system a clear outline. To be followed is a detailed description of detail operation flow path and each step thereof.

FIG. 6 is a flow chart showing a basic interaction while a user 5 employs a portable guide and guard device 1 to contact with a service center 3 according to the present invention. This flow path is namely the main operation mode of the whole portable guide and guard device 1 and the operation system.

FIG. 7 is a flow chart showing the processing procedures of the signal while the user 5 operates the independent portable guide and guard device 1A in a preferred embodiment according to the present invention.

FIG. 8 is a flow chart showing the processing procedures of the signal while the user operates the 3G mobile phone 1c with the external video/audio input/output device 1b of the separate portable guide and guard device 1B in a preferred embodiment according to the present invention.

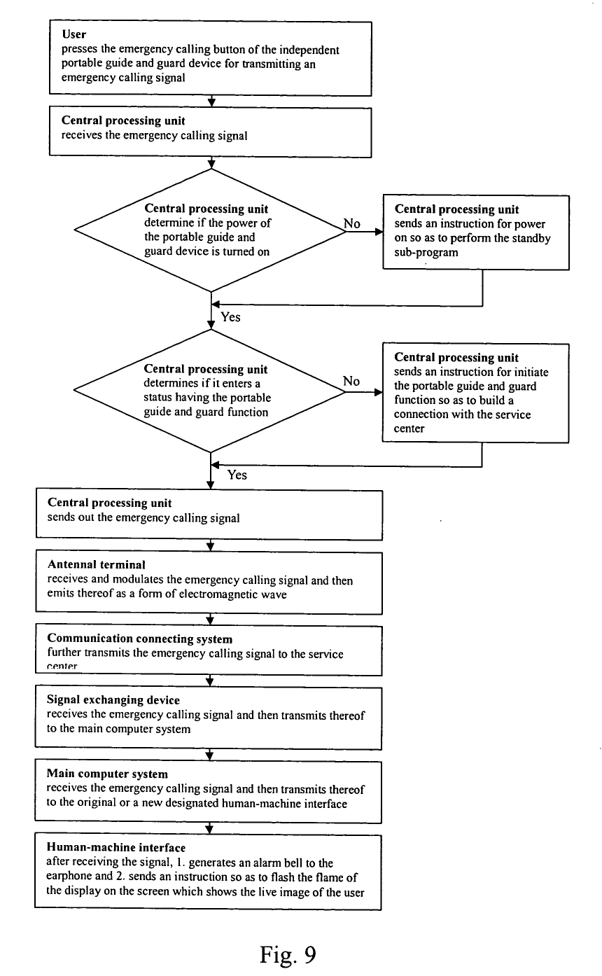

FIG. 9 is a flow chart showing an emergency calling system and the processing procedures of the signal thereof while the user 5 presses the emergency button 22a of the independent portable guide and guard device 1A in a preferred embodiment according to the present invention.

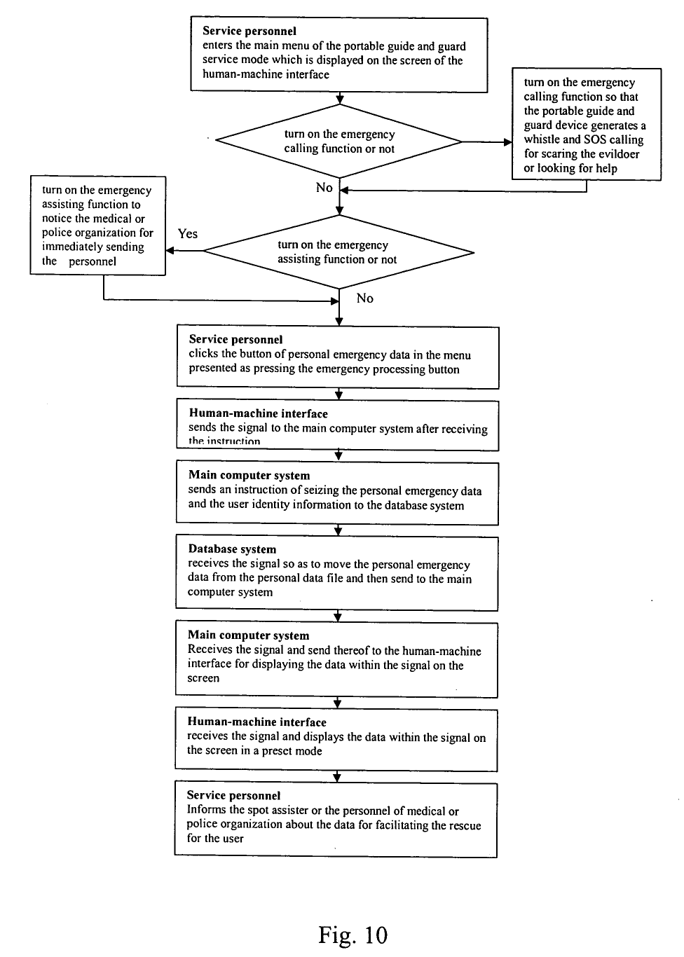

FIG. 10 is a flow chart showing the emergency measures and the processing procedures of the signal thereof while the service center receives an emergency call.

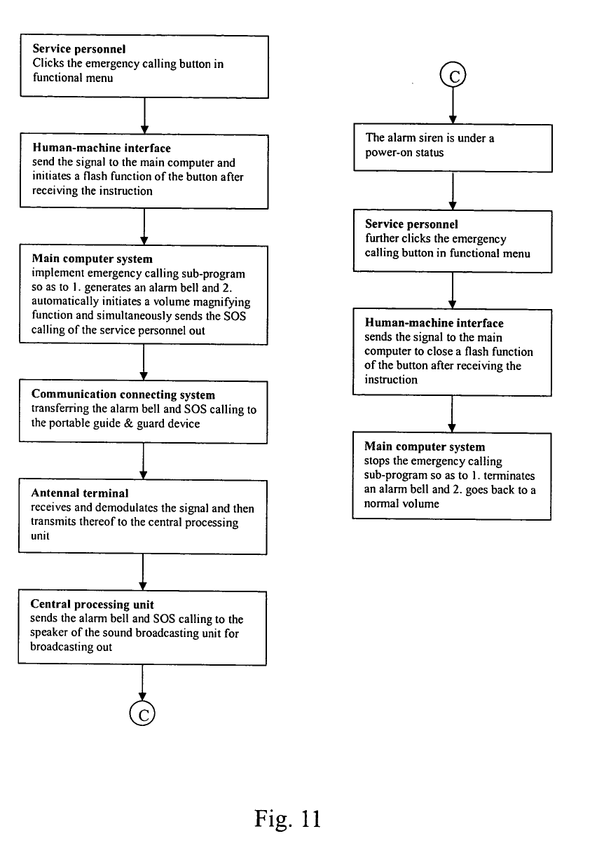

FIG. 11 is a flow chart showing the operation system and the processing procedures of the signal thereof while the service center employs a function of emergency calling in a preferred embodiment according to the present invention. This flow path is namely a detailed description of step 502 in FIG. 10.

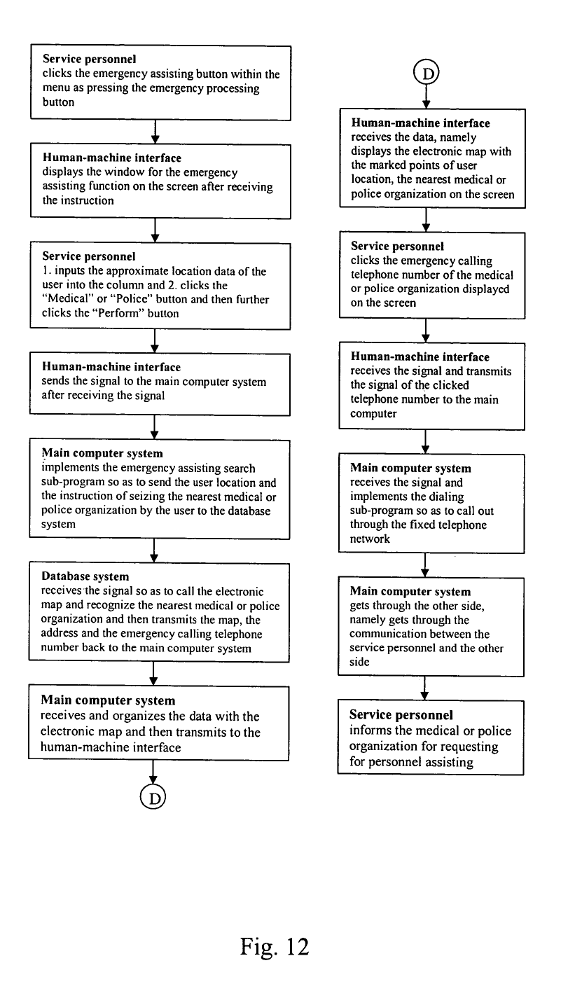

FIG. 12 is a flow chart showing the operation system and the processing procedures of the signal thereof while the service center employs a function of emergency assisting in a preferred embodiment according to the present invention. This flow path is namely the detailed description of the step of emergency assisting.

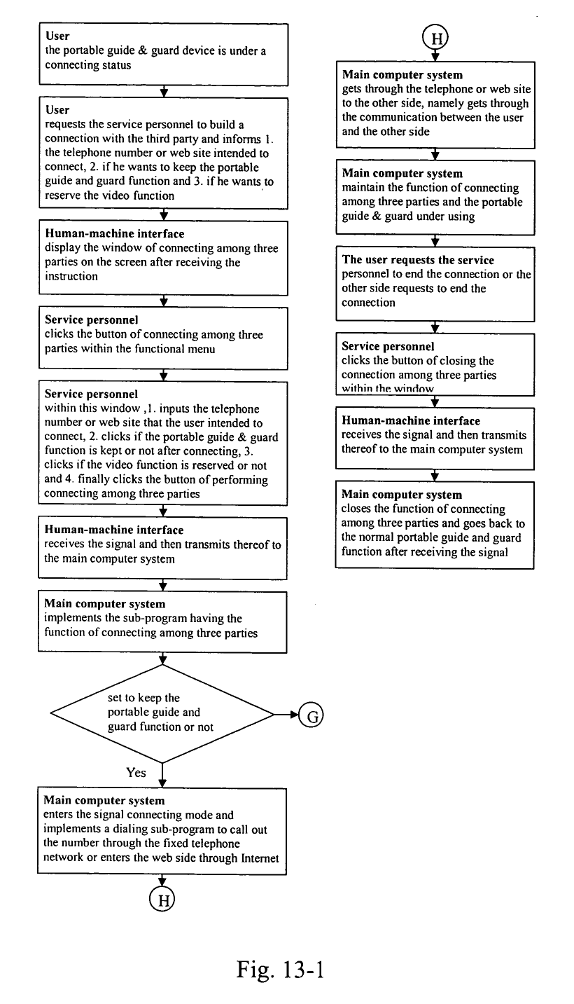

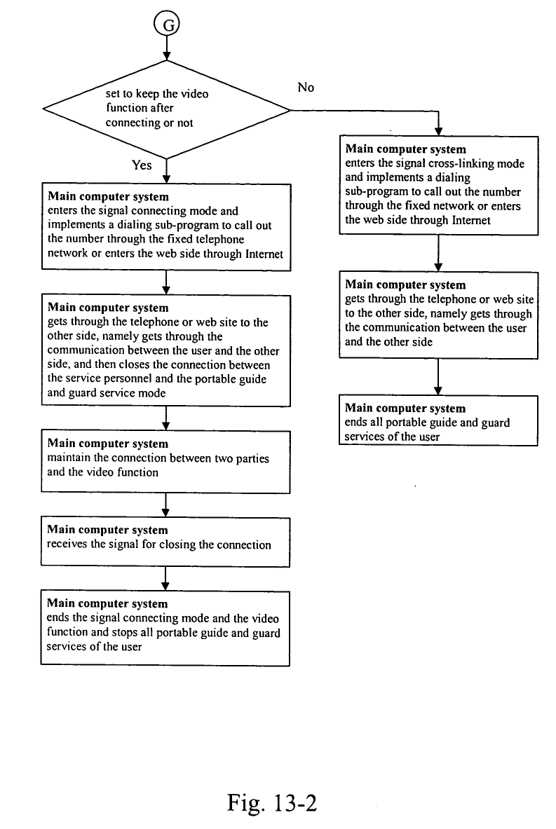

FIGS. 13-1 and 13-2 are a flow chart showing a connecting service among three parties which is provided by the service center through connecting the wireless communication ability thereof and of the user to a designated phone or web site and the processing procedures of the signal thereof in a preferred embodiment according to the present invention.

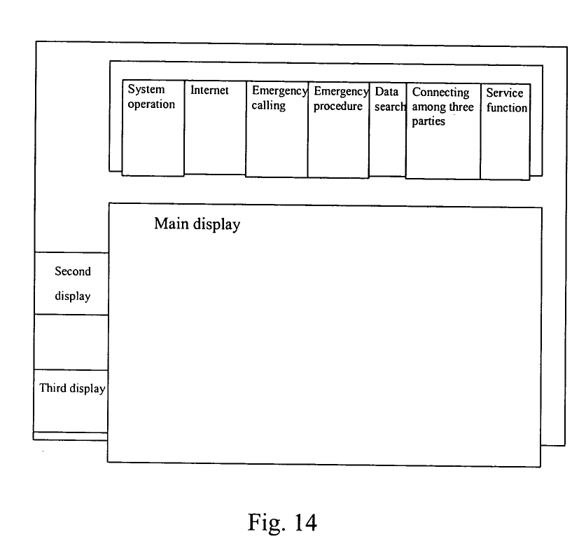

FIG. 14 is a schematic view showing a main menu shown on a monitor of a human-machine interface 36 within the service center 3 according to the present invention.

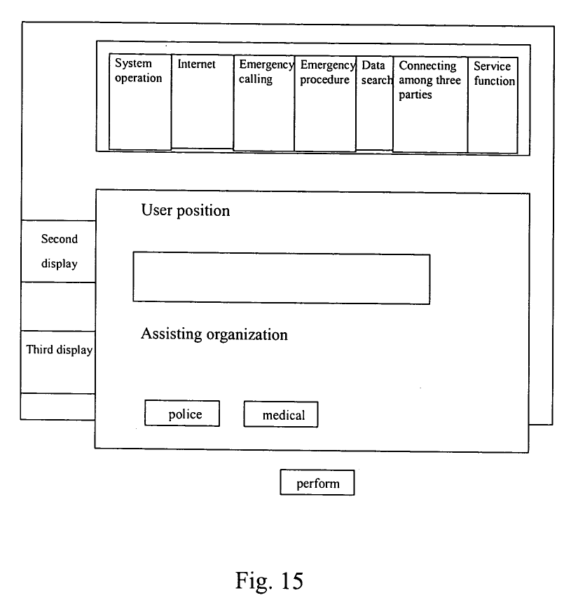

FIG. 15 is a schematic view showing emergency assisting functions shown on a monitor in a preferred embodiment according to the present invention.

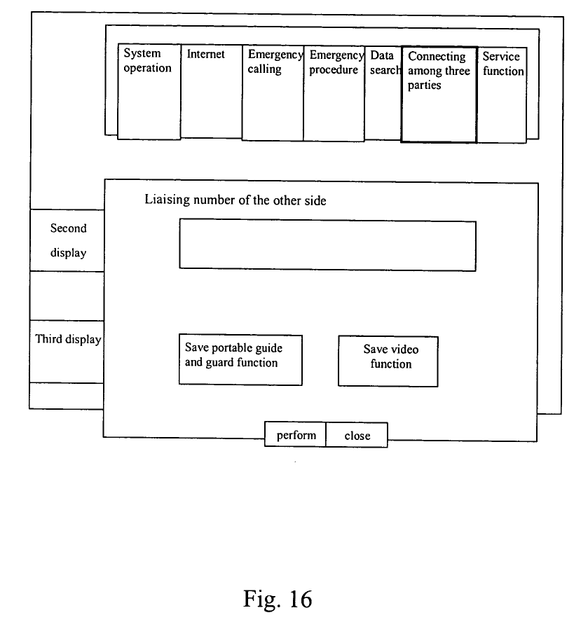

FIG. 16 is a schematic view showing functions of connecting among three parties shown on a monitor in a preferred embodiment according to the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for implementing a portable guide and guard system having a portable guide and guard device, a communication connecting system and an information service station, wherein:
said portable guide and guard device comprises a mini-camera, a central processing unit, a sound gathering unit, a sound broadcasting unit, an antennal terminal and a power unit;
said communication connecting system at least comprises a wireless communication network, a communication system and a wired communication network;
said information service station at least comprises a service center having plural sub-systems, wherein said plural sub-systems comprises a main computer system, a signal exchanging device, a database system, an internal network and plural human-machine interfaces; and
said method for implementing said portable guide and guard system comprises steps of:
1) receiving an external image via said mini-camera of said portable guide and guard device for generating a live video signal, receiving a sound from a user and/or an outside via a microphone of said sound gathering unit for generating a live audio signal, transmitting said video signal and said audio signal through said central processing unit of said portable guide and guard device to said antennal terminal of said portable guide and guard device and emitting said video and said audio signals by means of a wireless electromagnetic wave, wherein said portable guide and guard device is powered by said power unit;
2) receiving said wireless electromagnetic wave by a base station of said 3G wireless communication network and then transmitting said video and audio signals to said communication system;
3) exchanging and processing said video and audio signals by said communication system which relays said signals and then transmitting thereof to said wired communication network;
4) sending said video and audio signals to said remote service center through said wired communication network;
5) receiving said video and audio signals by said signal exchanging device of said service center, sending said video and audio signals to said main computer system after being processed by said signal exchanging device, simultaneously sending said video and audio signals to said database system for recording and to one of said plural human-machine interfaces through said internal network by said main computer system, depending on said received image and said received sound from said user and/or outside, a service personnel at said human-machine interface implements necessary processing procedures and then sending a responding dialogue through a microphone of said human-machine interface in response to said image and said sound, and transmitting a voice signal of said responding dialogue out sequentially through said human-machine interface, said internal network, said main computer system and said signal exchanging device in said service center;
6) reverse-transmitting said voice signal from said service center to said portable guide and guard device of said user through the same pathway so as to assist said user to converse with said service center and set forth questions through the connection therebetween.

2. The method as claimed in claim 1, wherein said information service station further comprises an Internet, an Internet connection network between said service center and said Internet and an Internet server, which is added in said sub-systems of said service center, so that said service center cooperates an Internet information obtained from said Internet due to a searching ability thereof with an information transmitting ability achieved by said method so as to implement said portable guide and guard system and provide the Internet information and all kinds of on-line services to said user over the Internet.

3. The method as claimed in claim 1, wherein said wireless communication network and said communication system both are 3G wireless mobile communication systems.

4. A detached portable guide and guard device for coupling to a portable guide and guard system, comprising a mini-camera, a central processing unit, a sound gathering unit, a sound broadcasting unit, an antennal terminal and a power unit, wherein:
said mini-camera at least comprises an optical camera and an image processing element, wherein after an external optical image captured by said optical camera passes through said image processing element, an analog signal thereof is transformed into a digital signal which is then inputted into said central processing unit for processing a signal output procedure;
said central processing unit is a computer component, wherein a video signal from said mini-camera and an audio signal from a microphone, which are passed through said output signal procedure, are transmitted to said antennal terminal by said central processing unit for emitting a wireless electromagnetic wave and an external electromagnetic wave received by said antennal terminal is decoded by said central processing unit and then transmitted to said sound broadcasting unit for broadcasting the sound;
said sound gathering unit comprises a fixed microphone positioned above a panel of said device and a sound gathering element position inside said device, wherein an external sound is received by said fixed microphone, transmitted to said sound gathering element for proceeding a signal processing, and then transmitted to said central processing unit for proceeding an output processing of the sound signal;
said sound broadcasting unit comprises a fixed speaker and an external earphone position above said panel of said device and a sound broadcasting element positioned inside said device, wherein a voice signal received by said antennal terminal is processed by said sound broadcasting element and then transmitted to said speaker, said external earphone and an external earphone of said microphone so as to broadcast the sound;
said antennal terminal at least comprises an emitter, a receiver and an antenna, wherein an encoded signal from said central processing unit is electro-magnetically modulated by said emitter so that a wireless electromagnetic wave signal is emitted through said antenna, and a wireless electromagnetic wave signal received by said antenna from said wireless communication network is demodulated by said receiver and then transmitted to said central processing unit for signal decoding and processing other sequential procedures; and
said power unit is a high efficiency battery, wherein said battery has an ability of measuring residue power for warning the user a low power status.

5. The device as claimed in claim 4, wherein said device comprises a power switch, a button of portable guide and guard function, a speaker mute button, a volume regulating button, an earphone/microphone socket, an antenna and a status indicator, which are external operating and display elements.

6. The device as claimed in claim 5, wherein said external operating and display elements further comprises an emergency calling button for notifying a service center and looking for an immediate assistance under an emergency situation.

7. A separate portable guide and guard device for coupling to a portable guide and guard system, comprising a 3G mobile phone and an external video/audio input/output device, wherein:
said external video/audio input/output device comprises a mini-camera, a microphone, a speaker, a power/signal line and a plug thereof for connecting to said 3G mobile phone and an emergency calling button; and
said 3G mobile phone comprises:
1) a central processing unit for processing all signals, data and control instructions in said external video/audio input/output device;
2) a sound gathering unit having an external microphone accessory and a sound gathering element, wherein an external sound received by said microphone of said external video/audio input/output device is inputted into said sound gathering element of said 3G mobile phone through said power/signal line and, on the other hand, a voice from said external microphone accessory is transmitted to said central processing unit of said 3G mobile phone for proceeding a voice output processing, and furthermore, said sound gathering element has an ability of echo elimination which is initiated when said microphone of said external video/audio input/output device and said external microphone accessory of said 3G mobile phone are simultaneously operated so as to reduce an echo;
3) a sound broadcasting unit having an external earphone accessory and a broadcasting element, wherein a voice signal received from an antennal terminal of said 3G mobile phone is processed by said broadcasting element and then transmitted to said speaker of said external video/audio input/output device through said power/signal line for broadcasting said voice, and, on the other hand, a voice from a service center is received through said external earphone of said 3G mobile phone;
4) an antennal terminal for emitting and receiving a wireless electromagnetic wave of said external video/audio input/output device;
5) a power unit for supplying all power demanded by said external video/audio input/output device;
6) a power switch, wherein after said plug of said power/signal line of said external video/audio input/output device is plugged into a socket of said 3G mobile phone, said power switch immediately has an ability to initiate a power supply, and then said external video/audio input/output device is synchronous to an operation of said power switch of said 3G mobile phone;
7) a function of power on/off said portable guide and guard, wherein after said plug of said power/signal line of said external video/audio input/output device is plugged into said socket of said 3G mobile phone, said portable guide and guard function is initiated/shut down through pressing a confirm button of said 3G mobile phone;
8) a function of speaker mute which is initiated/shut down through choosing a mute sub-selection in a menu of portable guide and guard of said 3G mobile phone;
9) a volume regulating button for also controlling a volume of said speaker of said external video/audio input/output device; and
10) an earphone/microphone socket for externally connecting an earphone/microphone accessory to obtain a sound gathering function from said microphone and a sound broadcasting function from said earphone.
